(19) United States
(12) Patent Application Publication
(10) Pub. No.: US 2012/0260651 A1
(43) Pub. Date: Oct. 18, 2012

(54) WASTE GATE ARRANGEMENT FOR A TURBINE, TURBINE FOR AN EXHAUST GAS TURBOCHARGER, EXHAUST GAS TURBOCHARGER, MOTOR VEHICLE, AND METHOD FOR OPERATING AN EXHAUST GAS TURBOCHARGER

(75) Inventors: Ralf Böning, Reiffelbach (DE); Roland Herfurth, Regensburg (DE); Christoph Sparrer, Regensburg (DE); Christian Uhlig, Worms (DE)

(73) Assignee: CONTINENTAL AUTOMOTIVE GMBH, HANNOVER (DE)

(21) Appl. No.: 13/499,780

(22) PCT Filed: Sep. 23, 2010
(86) PCT No.: PCT/EP2010/064069

§ 371 Date: Jun. 26, 2012

(30) Foreign Application Priority Data
Oct. 2, 2009 (DE) 10 2009 048 125.7

(51) Int. Cl. F02B 37/00; F01D 1/06; F01D 17/10

(52) U.S. Cl. 60/605.1; 415/145; 417/53

(57) ABSTRACT

A waste gate arrangement for a turbine, particularly for an exhaust gas turbocharger, has a waste gate valve for bypassing exhaust gas past the turbine. A waste gate shaft has first and second bearing locations rotatably supporting the shaft. A lever arm is rotationally fixedly mounted on the waste gate shaft and configured for placing the shaft in rotation when a lever arm force is applied to the lever arm. A waste gate flap is fixed on the shaft and controls the amount of exhaust gas flowing through the valve, and disposed relative to the first and the second bearing locations such that a lever arm normal force resulting from the lever arm force when opening and/or closing the waste gate valve and an exhaust gas normal force acting on the waste gate flap have opposite force action directions at one or both bearing locations.

The present invention relates to a waste gate arrangement for a turbine, a turbine for an exhaust gas turbocharger, an exhaust gas turbocharger, a motor vehicle, and a method for operating such an exhaust gas turbocharger.

DE 10 2004 041 166 A1 describes the known construction of a turbocharger for a motor vehicle, which essentially comprises a radial turbine and a radial compressor, which is arranged in the intake section of the engine and is coupled to the turbine rotor of the radial turbine for conjoint rotation by a turbocharger shaft. During operation, the exhaust gas flow, which has a high kinetic and thermal energy, drives the turbine rotor, which imparts rotation to the compressor impeller through the coupling to the turbocharger shaft. The radial compressor draws in air and compresses it, with the result that there is a correspondingly larger mass of fresh air and hence more oxygen available in the intake section of the engine than with a conventional naturally aspirated engine. There is thus an increase in the mean engine pressure and hence in the engine torque, leading to a higher power output from the engine.

One of the ways of controlling the amount of exhaust gas flowing through the turbine is to insert a “waste gate valve” on the turbine side of the turbocharger. A waste gate valve is a controllable bypass valve. At a set boost pressure on the compressor side, this valve directs some of the hot exhaust gases produced past the turbine and directly into the exhaust. This makes it possible to prevent an excessive rotational speed of the turbocharger and an associated overload of the bearings thereof as well as overshooting of the mechanical and thermal limits of the internal combustion engine.

Control of the amount of exhaust gas flowing through the waste gate valve is accomplished by means of a waste gate flap, for example. The waste gate flap is arranged for conjoint rotation on a waste gate shaft, also referred to as a waste gate spindle, for example, which is rotatably mounted in the turbine housing. The waste gate flap is actuated by way of a linear motion at an actuating lever of the waste gate shaft by means of a pneumatic or electric actuator. This linear motion gives rise to a torque at the waste gate shaft, thereby enabling the waste gate valve to be opened and closed.

Owing to the high exhaust gas temperatures, the waste gate spindle in the turbine housing is typically provided with sliding support in a bushing. Since the bushing and the waste gate spindle have different coefficients of thermal expansion due to their different material properties and since, furthermore, a very wide temperature range has to be covered in the exhaust gas turbocharger, the sliding support between the bushing and the waste gate shaft is subject to play. As a result, there is only point contact between these friction partners, not surface contact. Essentially two bearing locations are formed. One at an end of the sliding contact bushing associated with the outside of the turbine housing and one at an end of the sliding contact bushing remote from the outside of the turbine housing.

Both during the opening and during the closing of the waste gate valve, normal forces resulting from an actuating force of the lever arm and an exhaust gas force acting on the waste gate flap act at these bearing locations. During the closing of the waste gate valve these normal forces are added and cause a relatively high resultant normal force in the sliding contact bushing, leading to very high friction torques in the bearing locations. During the opening of the waste gate valve, the actuator for actuating the lever arm must hold the waste gate valve closed with a certain force to ensure that the waste gate flap is just pushed open by the exhaust gas flowing through the waste gate valve. Although the force required for this is less than during the closing of the waste gate valve, the forces resulting from the actuating force and the exhaust gas force act in the same direction of action of force in the bearing locations and are added. Thus, a not inconsiderable friction torque arises in the bearing locations during the opening of the waste gate valve as well. Since the actuator for actuating the actuating lever must overcome these friction torques, the maximum friction torque to be overcome is critical for the design of the actuator.

In applications involving a pneumatically activated waste gate valve, this has hardly been allowed for hitherto, and the disadvantages, such as a high leakage mass flow owing to an inadequate closing force of the actuator and hence non-optimum operation of the turbocharger at full load in the low engine speed range of the internal combustion engine, have been consciously accepted. In initial production applications for electric actuators for activating the waste gate valve, a very powerful electric actuator has been used to overcome the high friction torques. However, this leads to very high forces when the actuator is cold, and this can therefore lead to damage to the turbocharger. Moreover, the use of a powerful and therefore also large actuating means leads to high costs and a high installation space requirement.

Naturally, the aim is to avoid this.

Given this background, it is the underlying object of the present invention to provide an improved waste gate arrangement for a turbine.

According to the invention, this object is achieved by a waste gate arrangement having the features of patent claim 1 and/or by a turbine having the features of patent claim 10 and/or by an exhaust gas turbocharger having the features of patent claim 11 and/or by a motor vehicle having the features of patent claim 12 and/or by a method having the features of patent claim 13.

Accordingly, the following are provided: A waste gate arrangement for a turbine, particularly for an exhaust gas turbocharger, having a waste gate valve configured for directing exhaust gas past the turbine, having a waste gate shaft having a first bearing location and having a second bearing location, which are used to provide rotatable support for the waste gate shaft, having a lever arm mounted for conjoint rotation on the waste gate shaft and configured for imparting rotation to the waste gate shaft when a lever arm force is applied to the lever arm, and having a waste gate flap mounted for conjoint rotation on the waste gate shaft and controlling an amount of exhaust gas flowing through the waste gate valve and arranged relative to the first and the second bearing location in such a way that a lever arm normal force resulting from the lever arm force and an exhaust gas normal force resulting from an exhaust gas force acting on the waste gate flap have opposite directions of action of force in at least one of the bearing locations during opening and/or closing of the waste gate valve.

A turbine for an exhaust gas turbocharger, in particular for a motor vehicle, having a turbine housing, and having a waste gate arrangement according to the invention, wherein the waste gate valve, the first bearing location and the second bearing location are arranged in the turbine housing.

An exhaust gas turbocharger, in particular for a motor vehicle, having a turbine according to the invention, which has: a turbine rotor arranged in the turbine housing, a compressor having a compressor housing, a compressor impeller arranged in the compressor housing, and a turbocharger shaft, which connects the compressor impeller to the turbine rotor for conjoint rotation.

A motor vehicle having an exhaust gas turbocharger of this kind.

A method for operating an exhaust gas turbocharger which has a waste gate arrangement according to the invention, having a first operating mode, in which the waste gate flap is closed, wherein the lever arm normal force and the exhaust gas normal force at the first bearing location act in opposite directions of action of force and are approximately equal during the closing process, thereby producing a low bearing friction torque at the first bearing location.

The concept underlying the present invention consists then inter alia in that the waste gate shaft has two bearing locations and in that the waste gate flap is arranged on the waste gate shaft in such a way relative to the first and the second bearing location that the lever arm normal force and the corresponding exhaust gas normal force have opposite directions of action of force in at least one of the bearing locations during opening and/or closing of the waste gate valve. This makes it possible for the lever arm normal force and the exhaust gas normal force to cancel each other out at least partially in the bearing location concerned. The friction torque in the corresponding bearing location is thereby significantly reduced.

With the waste gate arrangement according to the invention, it is thus possible to ensure reliable opening and closing of the waste gate valve with an actuating means which is of smaller dimensions and is thus lighter and less costly. Advantageous embodiments and developments of the present invention will emerge from the dependent claims and from the description when taken in conjunction with the figures of the drawing.

In a preferred embodiment of the present invention, the lever arm is arranged at a first end of the waste gate shaft, the second bearing location is arranged at a second end of the waste gate shaft, the first bearing location is arranged between the lever arm and the second bearing location, and the waste gate flap is arranged on the waste gate shaft between the first bearing location and the second bearing location. This is an advantageous way of enabling the entire available length of the waste gate shaft to be used to achieve optimum lever ratios.

In a typical embodiment of the present invention, the waste gate shaft has a larger outside diameter at the first bearing location than at the second bearing location. As a result, the friction torques in the first bearing location are as large as possible during the opening of the waste gate valve. An increase in the friction effect during the opening of the waste gate valve has an advantageous effect on the decoupling of the actuating means from the pulsating gas forces of the exhaust gas. This significantly improves the control characteristic of the waste gate arrangement according to the invention and hence also the control characteristic of an exhaust gas turbocharger having a waste gate arrangement according to the invention.

In another preferred embodiment of the present invention, the waste gate shaft has two individual shafts, which can be inserted axially one inside the other, wherein the first bearing location is arranged on a first individual shaft designed as a hollow shaft, and wherein the second bearing location is arranged on a second individual shaft designed as a solid shaft. This significantly simplifies the production and also the mounting of the waste gate shaft, thereby markedly reducing production costs for the waste gate arrangement according to the invention.

In a particularly preferred embodiment of the present invention, the first and the second bearing location and the waste gate flap are arranged spaced apart in a longitudinal direction of the waste gate shaft. This makes it possible to set advantageous lever ratios, which can be set in such a way that the normal forces resulting from the lever force and the exhaust gas force have opposite directions of action of force and cancel each other out at least partially in at least one bearing location.

In another preferred embodiment of the present invention, the first bearing location, the second bearing location and the waste gate flap are spaced apart in such a way in the longitudinal direction of the waste gate shaft that the lever arm normal force and the exhaust gas normal force cancel each other out at a closing point of the waste gate valve, in which the waste gate valve is completely closed. This advantageously allows the required retention force of the actuating means to be markedly reduced at the closing point of the waste gate valve. As a result, the energy consumption of the actuating means is significantly reduced, thereby increasing the efficiency of an exhaust gas turbocharger having a waste gate arrangement according to the invention.

In an equally preferred embodiment of the present invention, the waste gate flap is coupled to the waste gate shaft by means of an arc-shaped intermediate piece. It is thereby advantageously possible to connect a valve element of the waste gate flap to the intermediate piece without play in a conventional manner by means of a rivet washer from the rear side of the arc-shaped intermediate piece. This makes it possible to manufacture the waste gate arrangement according to the invention in a production unit for known waste gate arrangements without increased outlay in terms of adaptation and costs. As a result, the production costs for the waste gate arrangement according to the invention are reduced.

In an equally preferred embodiment of the present invention, the waste gate flap has a rounded valve element. This ensures reliable sealing of the waste gate valve, thereby reliably preventing leaks of exhaust gas. This increases the efficiency of an exhaust gas turbocharger having a waste gate arrangement according to the invention since the entire amount of exhaust gas is passed through the turbine of the exhaust gas turbocharger when an internal combustion engine is operating at full load at high engine speed.

In a typical embodiment of the present invention, an actuating means, by means of which the lever arm force can be applied to the lever arm, is provided. The actuating means ensures reliable positioning of the waste gate valve in the desired position, and it is thereby possible to set the desired degree of opening of the waste gate valve and hence to ensure the functionality of an exhaust gas turbocharger having a waste gate arrangement according to the invention.

In a preferred embodiment of the present invention, a second operating mode is provided, in which the waste gate flap is completely closed, wherein a closing point of the waste gate flap is chosen in such a way that the lever arm normal force and the exhaust gas normal force cancel each other out in the first bearing location. As a result, it is advantageously possible to reduce the dimensions of the actuating means. The weight, installation space and production costs for the waste gate arrangement according to the invention are thereby reduced.

In another preferred embodiment of the present invention, a third operating mode is provided, in which the waste gate flap is opened, wherein the lever arm normal force and the exhaust gas normal force at the first bearing location during the opening process act in opposite directions of action of force and the exhaust gas normal force is greater than the lever arm normal force, thereby producing a high bearing friction torque at the first bearing location. Decoupling of the actuating means from the pulsating exhaust gas normal forces is advantageously possible by means of a high bearing friction torque during the opening of the waste gate valve. This significantly improves the control characteristic of an exhaust gas turbocharger having a waste gate arrangement according to the invention.

The above embodiments can be combined in any desired manner insofar as this is reasonable.

The present invention is explained in greater detail below with reference to the illustrative embodiments given in the schematic figures of the drawing, in which:

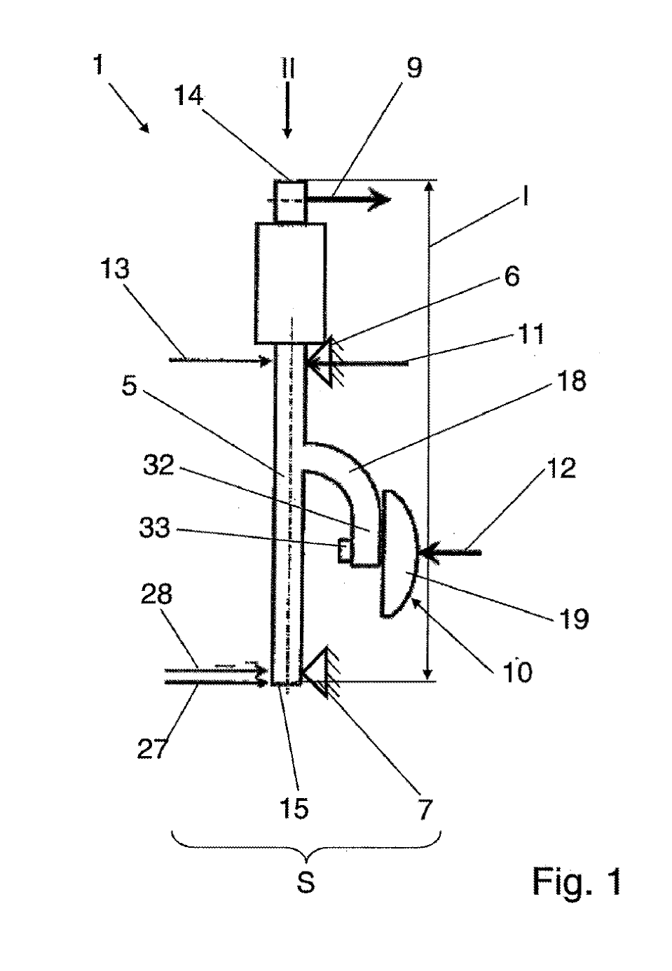

FIG. 1 shows a plan view of a preferred embodiment of a waste gate arrangement according to the invention during the closing of a waste gate valve;

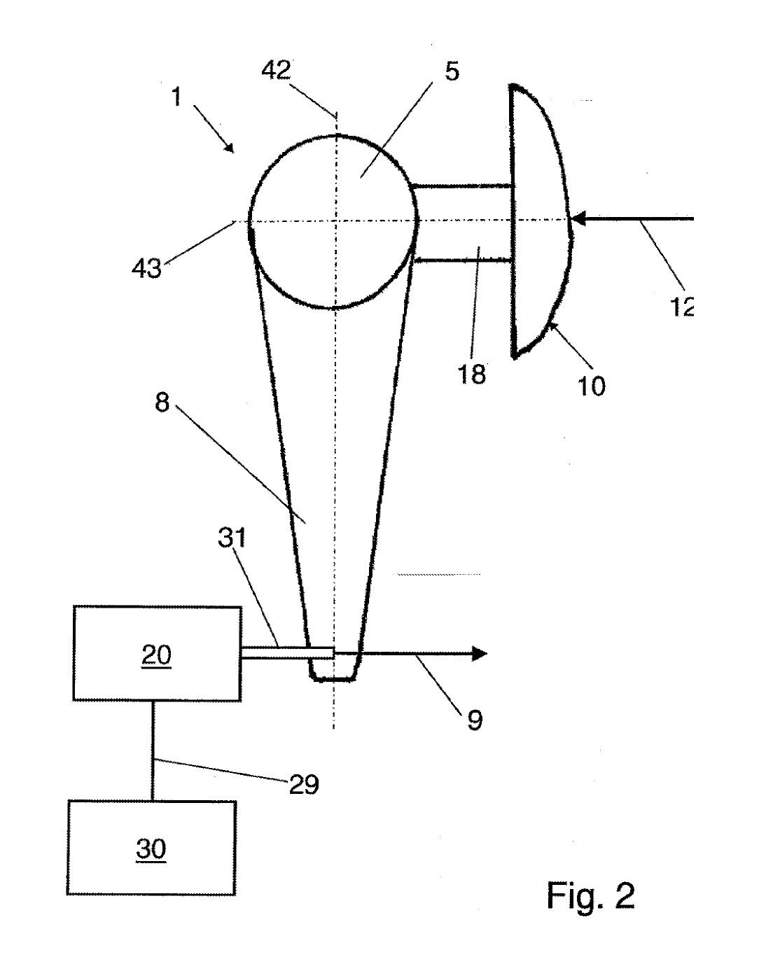

FIG. 2 shows a front view of the preferred embodiment of the waste gate arrangement according to the invention as per FIG. 1 in direction of view II;

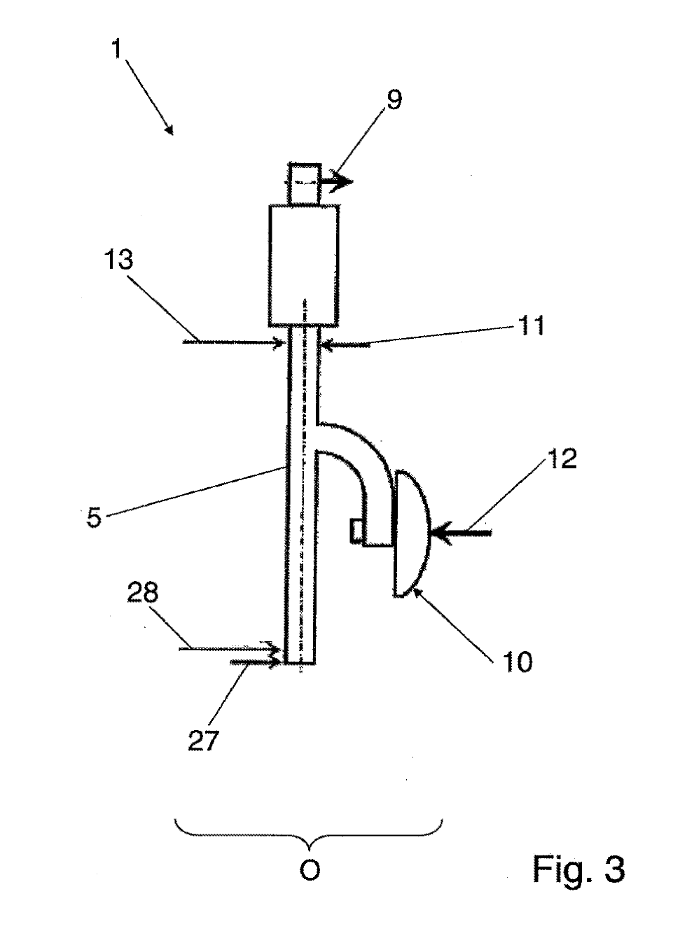

FIG. 3 shows a plan view of the preferred embodiment of the waste gate arrangement according to the invention as per FIG. 1 during the opening of the waste gate valve;

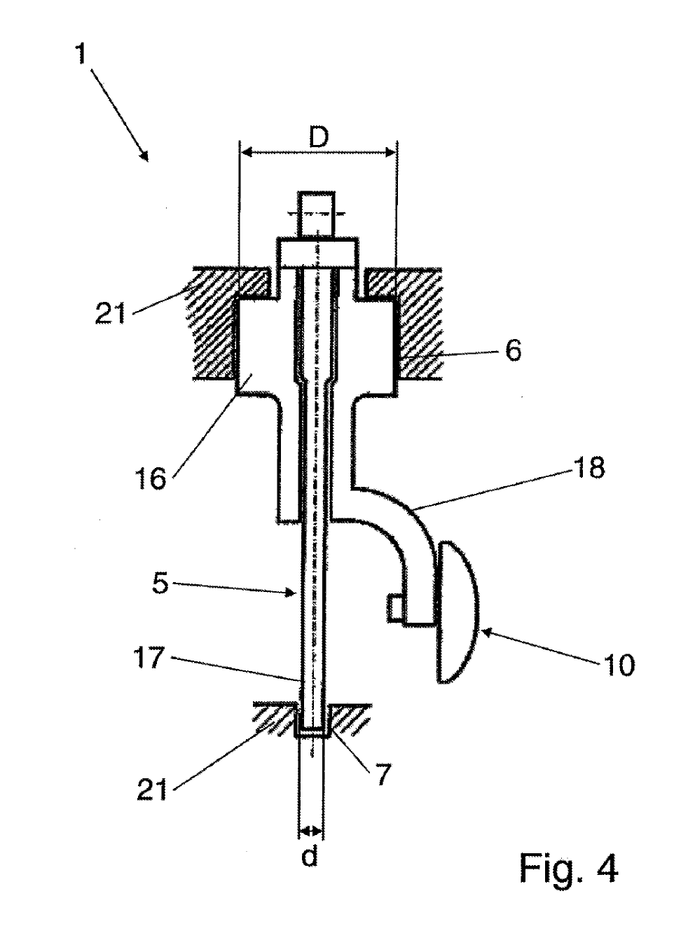

FIG. 4 shows a plan view of another preferred embodiment of a waste gate arrangement according to the invention;

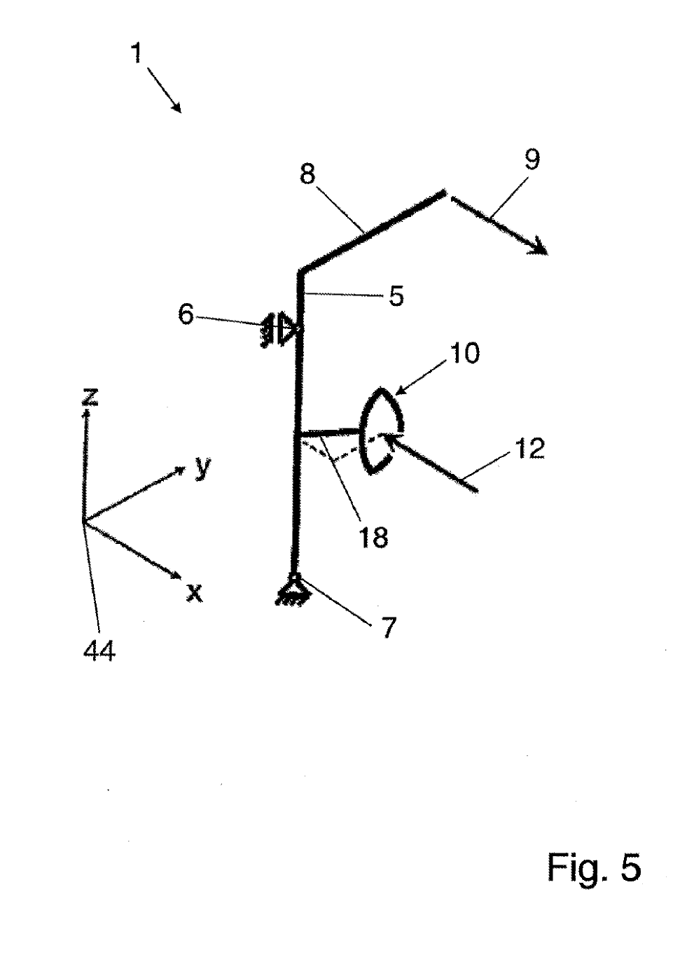

FIG. 5 shows a simplified representation of the preferred embodiment of the waste gate arrangement according to the invention as per FIG. 1 during the closing of the waste gate valve;

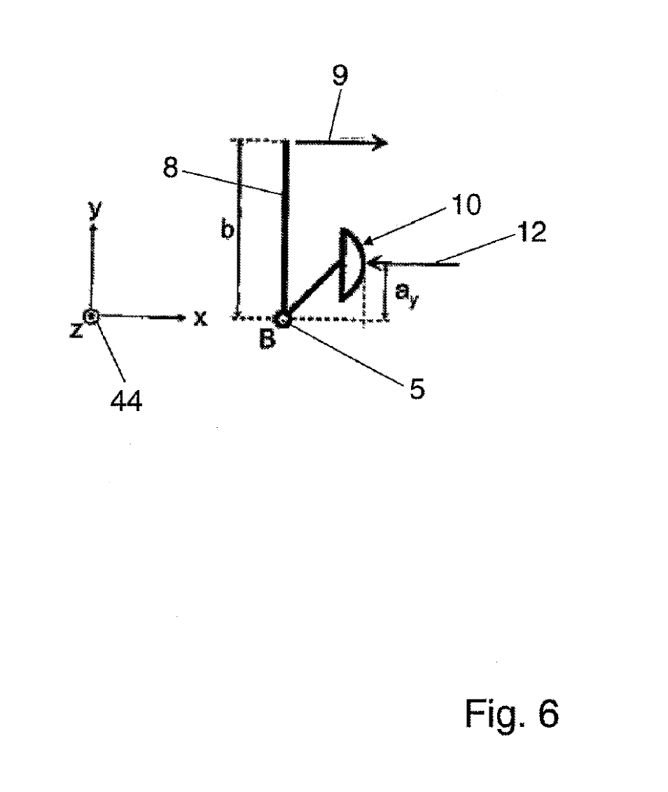

FIG. 6 shows a torque equilibrium of the arrangement shown in FIG. 5 about the z axis;

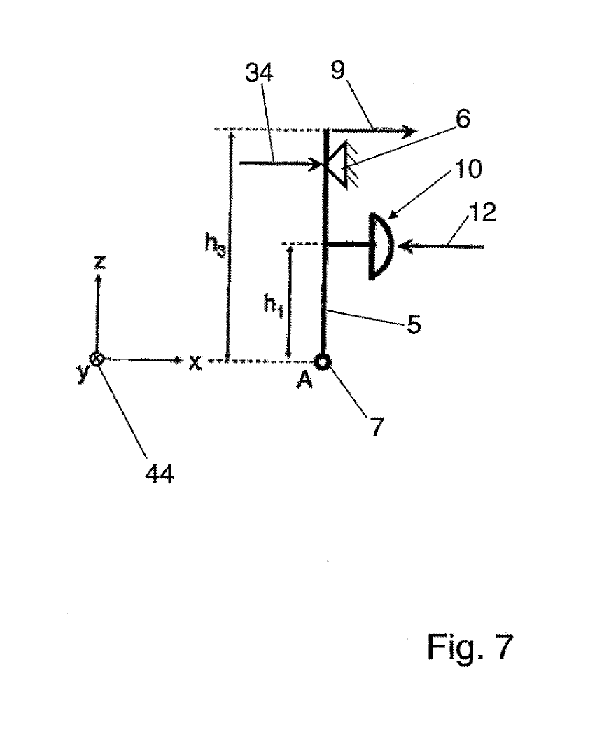

FIG. 7 shows a torque equilibrium of the arrangement shown in FIG. 5 about the y axis;

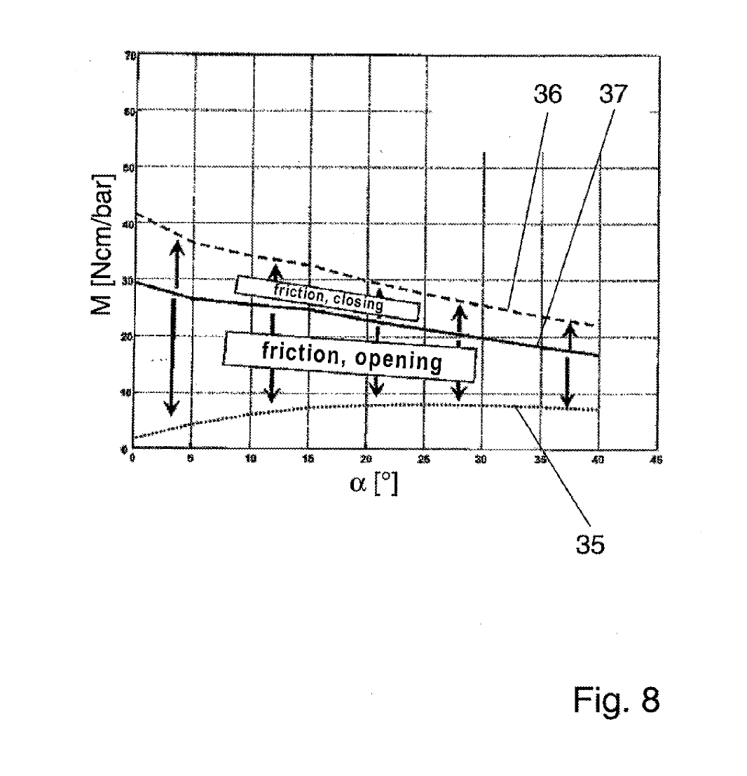

FIG. 8 shows a representation of friction torque curves at a waste gate shaft as a function of the exhaust gas pressure at a waste gate valve; and

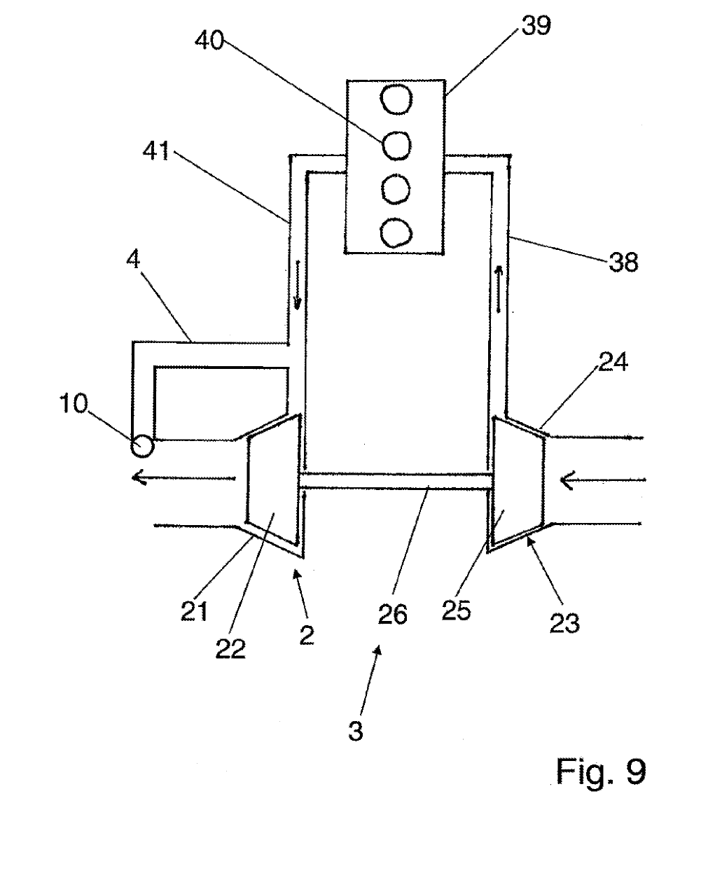

FIG. 9 shows a plan view of a preferred embodiment of an exhaust gas turbocharger according to the invention having a waste gate arrangement as per FIG. 1.

Unless otherwise stated, identical components, elements and features have been provided with the same reference signs in the figures of the drawing.

FIG. 1 illustrates a plan view of a preferred embodiment of a waste gate arrangement according to the invention during the closing of a waste gate valve.

FIG. 1 shows a waste gate arrangement 1 having a waste gate shaft 5, which has a first end 14 and a second end 15. The waste gate shaft 5 is also referred to as a waste gate spindle. The waste gate shaft 5 furthermore has an arc-shaped intermediate piece 18, which extends approximately perpendicularly from a circumferential surface of the waste gate shaft 5 and describes a 90° arc until the arc-shaped intermediate piece 18 merges into a fixing portion 32, which extends approximately parallel to the waste gate shaft 5 and is used to fix a valve element 19 of a waste gate flap 10 on the waste gate shaft 5. The valve element 19 of the waste gate flap 10 is preferably fixed with play on the fixing portion 32. Fixing can be accomplished by means of a rivet washer 33, for example. As an alternative, the valve element 19 of the waste gate flap can also be arranged for conjoint rotation on the waste gate shaft 5 without the arc-shaped intermediate piece 18 and the fixing portion 32. On a front side facing away from the waste gate shaft 5, the valve element 19 has a rounded, in particular hemispherical shape. The waste gate shaft 5 has a first bearing location 6 and a second bearing location 7, the latter being associated with the second end 15 of the waste gate shaft 5. One of the bearing locations 6, 7 is preferably designed as a fixed location bearing, e.g. the second bearing location 7, while the first bearing location 6 is designed as a floating bearing, for example. Increases in the length of the waste gate shaft 5 due to the high service temperatures are thereby reliably compensated. The bearing locations 6 and 7 are designed as sliding bearing locations in a turbine housing of an exhaust gas turbocharger, for example. Relative to a longitudinal direction 1 of the waste gate shaft 5, the waste gate flap 10 is arranged between the first and the second bearing location 6, 7. A lever arm (not shown in FIG. 1), by means of which a torque can be applied to the waste gate shaft 5, is provided at the first end 14 of the waste gate shaft 5. The lever arm is acted upon by a lever arm force 9, which can be applied to the lever arm perpendicularly to the waste gate shaft 5 by means of an actuating means, for example. An exhaust gas force 12 acts perpendicularly on the valve element 19 of the waste gate flap 10. The exhaust gas force 12 results from an exhaust gas flow, which flows through a waste gate valve (not shown in FIG. 1) and presses on the valve element 19. The waste gate valve is preferably designed as a hole in a turbine housing of an exhaust gas turbocharger, connecting a turbine inlet of the turbine to an exhaust of an internal combustion engine. By virtue of the fact that the valve element 19 is preferably coupled with play to the waste gate shaft 5, the valve element 19 automatically fits into a valve seat of the waste gate valve during the closing of the waste gate valve. It is thereby possible to minimize leaks of exhaust gas.

The operation of the waste gate arrangement 1 according to the invention during closing S of the waste gate valve is explained below.

During the closing of the waste gate valve, the lever arm force 9 is applied to the lever arm, thereby imparting rotation to the waste gate shaft 5. During the closing of the waste gate valve, the exhaust gas flowing through the waste gate valve presses against the valve element 19 and tends to force it out of the valve seat of the waste gate valve. The exhaust gas force 12 thus causes a torque which acts on the waste gate shaft 5 in the opposite direction to a torque resulting from the lever arm force 9. A lever arm normal force 11 resulting from the lever arm force 9 and an exhaust gas normal force 13 resulting from the exhaust gas force 12 and acting counter to the lever arm normal force 11 acts in the first bearing location 6. A lever arm normal force 27 resulting from the lever arm force 9 and an exhaust gas normal force 28 resulting from the exhaust gas force 12 acts in the second bearing location 7. The lever arm normal force 27 and the exhaust gas normal force 28 have the same direction of action of force, for example.

The waste gate flap 10 is arranged on the waste gate shaft 5 between the first and the second bearing location 6, 7 in the longitudinal direction 1 in such a way that the lever arm normal force 11 and the exhaust gas normal force 13 preferably have opposite directions of action of force in the first bearing location 6 and cancel each other out at least partially. The lever arm normal force 11 and the exhaust gas normal force 13 preferably cancel each other out completely at a closing point of the waste gate valve, at which the waste gate valve is completely sealed by means of the valve element 19. By virtue of the fact that the lever arm normal force 11 and the exhaust gas normal force 13 cancel each other out at least partially at the first bearing location 6, the friction torques in the first bearing location 6 resulting from a bearing normal force representing a resultant of forces 11 and 13 is small. As a result, an actuating means for adjusting the waste gate shaft 5 can be given smaller dimensions.

FIG. 2 shows a front view of the preferred embodiment of the waste gate arrangement according to the invention as per FIG. 1 in the direction of view II.

FIG. 2 illustrates the waste gate arrangement 1 having the waste gate shaft 5, the arc-shaped intermediate piece 18 and the waste gate flap 10. The waste gate flap 10 is acted upon by the exhaust gas force 12. A lever arm 8 is mounted for conjoint rotation on the waste gate shaft 5. A center plane 42 of the lever arm 8 and a center plane 43 of the waste gate flap 10 preferably enclose approximately a right angle. The lever arm 8 is coupled to the waste gate shaft 5 by means of a positive joint, such as a splined shaft joint, a material joint, such as a welded joint, or a nonpositive joint, such as a clamped joint, for example. The waste gate arrangement 1 furthermore has an actuating means 20, which is connected to the lever arm 8 by a coupling 31. The coupling 31 is designed as a linkage, for example. The actuating means 20 is preferably an electric or pneumatic actuator. An engine controller 30 of an internal combustion engine is connected to the actuating means 20 by a data line 29.

The lever arm force 9 can be applied to the lever arm 8 by the actuating means 20 via the coupling 31. The application of the lever arm force 9 to the lever arm 8 imparts rotation to the waste gate shaft 5. In this way, the waste gate valve can be closed or opened. The engine controller 30 transmits the control command for opening or closing the waste gate valve to the actuating means 20 via the data line 29, depending on the operating state of the internal combustion engine.

FIG. 3 shows a plan view of the preferred embodiment of the waste gate arrangement according to the invention as per FIG. 1 during the opening of the waste gate valve.

FIG. 3 shows the waste gate shaft 5 having the waste gate flap 10, the lever arm force 9 acting on the lever arm and the exhaust gas force 12 acting on the waste gate flap 10. To simplify the illustration, FIG. 3 shows the waste gate shaft 5 without the first and the second bearing location and without the actuating means.

The operation of the waste gate arrangement 1 according to the invention during opening O of the waste gate valve is explained below.

During the opening O of the waste gate valve, the exhaust gas force 12 presses against the waste gate flap 10 in such a way that the waste gate flap 10 is just pushed open. This means that the actuating means must apply a lever arm force 9 via the lever arm which just allows the exhaust gas to push open the waste gate flap 10. As a result, the lever arm normal forces 11 and 27 at the first and the second bearing location, respectively, are smaller than the exhaust gas normal forces 13 and 28 in the first and the second bearing location, respectively. At the first bearing location, the lever arm normal force 11 and the exhaust gas normal force 13 act in opposite directions and cancel each other out at least partially. Owing to the fact that the lever arm normal force 11 and the exhaust gas normal force 13 do not cancel each other out completely during opening O, a higher friction torque is produced in the first bearing location in comparison with the closing of the waste gate valve. As a result, the actuating means is advantageously decoupled from the generally pulsating exhaust gas force 12, resulting in a significant improvement in the control characteristic of a turbine of an exhaust gas turbocharger having a waste gate arrangement according to the invention.

FIG. 4 shows a plan view of another preferred embodiment of a waste gate arrangement according to the invention.

FIG. 4 shows a waste gate arrangement 1 having the waste gate shaft 5, the arc-shaped intermediate piece 18 and the waste gate flap 10. FIG. 4 furthermore shows the first and the second bearing location 6, 7, which are arranged in a turbine housing 21, only part of which is shown. In this illustrative embodiment of the waste gate arrangement 1 according to the invention, the waste gate shaft 5 has a diameter D at the first bearing location 6 which is significantly greater than a diameter d of the waste gate shaft 5 at the second bearing location 7. To enable the waste gate shaft 5 in the embodiment shown to be mounted in an advantageous manner and produced at low cost, this shaft is preferably formed by a first individual shaft 16, which is designed as a hollow shaft, and by a second individual shaft 17, which is designed as a solid shaft. The second individual shaft 17 is guided by the first individual shaft 16 and is connected to the latter for conjoint rotation, e.g. by means of a splined shaft joint. As an alternative, the waste gate shaft 5 can also be of integral design.

Since there are virtually no bearing normal forces acting at the first bearing location 6 during the closing of the waste gate valve as described above because the lever arm normal force and the exhaust gas normal force in the first bearing location cancel each other out almost completely, the large diameter D of the first bearing location 6 has virtually no effect on the friction torques which arise during closing, which the actuating means would have to overcome in addition to the torque resulting from the exhaust gas force.

In the second bearing location 7, the effect of friction is minimized by means of a shaft diameter d which is as small as possible.

If, on the other hand, the waste gate valve is opened, the bearing normal force in the first bearing location 6 rises and generates a large friction torque owing to the large shaft diameter D. As a result, the actuating means is advantageously decoupled from the generally pulsating exhaust gas force during the opening of the waste gate valve, thereby allowing a significant improvement in the control characteristic of a waste gate arrangement 1 of this kind.

FIG. 5 shows a simplified perspective representation of the preferred embodiment of the waste gate arrangement according to the invention as per FIG. 1 during the closing of the waste gate valve.

FIG. 5 illustrates the waste gate shaft 5 with the first bearing location 6, the second bearing location 7, the lever arm 8, the arc-shaped intermediate piece 18 and the waste gate flap 10 arranged on the arc-shaped intermediate piece 18. The lever arm 8 is acted upon by the lever arm force 9. The waste gate flap 10 is acted upon by the exhaust gas force 12. FIG. 5 furthermore shows the waste gate arrangement 1 in relation to a coordinate system 44 having an x, a y and a z axis. The first bearing location 6 is designed as a floating bearing and the second bearing location 7 is designed as a fixed location bearing. The waste gate shaft 5 is parallel to the z axis of the coordinate system 44.

FIG. 6 shows a torque equilibrium of the arrangement shown in FIG. 5 about the z axis.

FIG. 6 illustrates the waste gate shaft 5, which lies on the z axis of the coordinate system 44, with the lever arm 8 and the waste gate flap 10. The waste gate flap 10 is acted upon by the exhaust gas force 12, and the lever arm 8 is acted upon by the lever arm force 9. In setting up a torque equilibrium about a center of rotation B, which corresponds to an axis of rotation of the waste gate shaft 5, the following relation is obtained with a length b of the lever arm 8 and a length a_{y} which corresponds to a lever arm of the exhaust gas force 12 effective about point B:

$$\sum {M}_{zB} \text{:} {F}_{bar} = {F}_{gas} \frac{{a}_{y}}{b}$$

where:
ΣM_{zB}ΣM_{zB} is the sum of the torques about the z axis around point B,
F_{bar} is the lever arm force, 9, and
F_{gas} is the exhaust gas force, 12.

FIG. 7 shows a torque equilibrium of the arrangement shown in FIG. 5 about the y axis.

FIG. 7 shows the waste gate shaft 5 with the first and the second bearing location 6, 7 and the waste gate flap 10. The lever arm is acted upon by the lever arm force 9 and the waste gate flap 10 is acted upon by the exhaust gas force 12. A resultant first bearing normal force 34, which is the resultant of the exhaust gas normal force and the lever arm normal force in the first bearing location 6, acts in the first bearing location 6. FIG. 7 relates to a torque equilibrium of the torques acting about the y axis of the coordinate system 44 at a center of rotation A which corresponds to the second bearing location 7. The exhaust gas force 12 acts with a lever arm of length h₁ about the center of rotation A. The lever arm force 9 likewise acts about the center of rotation A with a lever arm of length h₃. Assuming that the resultant bearing normal force 34 in the first bearing location 6 is equal to zero, the following relation is obtained:

$$\sum {M}_{zA} \text{:} {F}_{bar} = {F}_{gas} \frac{{h}_{1}}{{h}_{3}}$$

where:
ΣM_{zA}ΣM_{zA} the sum of the torques about the z axis around point A,
F_{bar} is the lever arm force, 9, and F_{gas} is the exhaust gas force, 12.

With the torque equilibrium about the z axis ΣM_{zA}ΣM_{zA} and the torque equilibrium about the z axis ΣM_{zB}ΣM_{zB}, the optimum lever ratio is obtained, at which the normal the resulting in the first bearing location 6 from the lever arm force 9 and the exhaust gas force 12 cancel each other out completely, and the resultant bearing normal force 34 is thus equal to zero:

$$\frac{{a}_{y}}{b} = \frac{{h}_{1}}{{h}_{3}}$$

With this lever ratio, a minimum friction torque is produced in the first bearing location 6 during the closing of the waste gate valve.

FIG. 8 shows a representation of friction torque curves at a waste gate shaft as a function of the exhaust gas pressure at a waste gate valve.

FIG. 8 illustrates a diagram showing torque curves during the opening and closing of a waste gate valve. The illustrated torque M at the waste gate valve is scaled to an exhaust gas pressure at the waste gate valve and is plotted against an angle of rotation a of the waste gate shaft. The effect of the exhaust gas pressure is that the exhaust gas force acts on the waste gate flap. Via the waste gate flap, an exhaust gas torque 37 is exerted on the waste gate shaft. During the closing of the waste gate valve, the actuating means must overcome the exhaust gas torque 37 and a closing friction torque 36. During the opening of the waste gate valve, the waste gate valve is pushed open by the exhaust gas. The actuating means must act against an opening friction torque 35 and just against the exhaust gas torque 37.

Owing to a reduction in the friction effect during the closing of the waste gate flap, it is possible to select a smaller and hence less costly actuating means since the maximum torque required to close the waste gate flap falls.

Increasing the friction effect during the opening of the waste gate valve has an advantageous effect on the decoupling of the actuating means from the generally pulsating forces of the exhaust gas. During the opening of the waste gate valve, the waste gate flap is just pushed open by the exhaust gas. The actuating means therefore does not have to supply a high torque during opening.

Through appropriate support for the waste gate shaft and appropriate lever ratios and shaft diameters in the first and the second bearing location, the waste gate arrangement according to the invention can thus be modified in such a way that the friction torques during the closing of the waste gate valve are as far as possible equally small and are as large as possible during the opening of the waste gate valve. This enables the actuating means to be given smaller dimensions, resulting in a fall in the procurement costs thereof, the required installation space and the energy consumption.

FIG. 9 shows a plan view of a preferred embodiment of an exhaust gas turbocharger according to the invention having a waste gate arrangement as per FIG. 1.

An internal combustion engine 39 having a plurality of cylinders 40 is coupled in terms of fluid flow by an exhaust line 41 to a turbine rotor 22 of a turbine 2, said rotor being arranged in a turbine housing 21. The waste gate valve 4 having the waste gate flap 10 forms a bypass around the turbine 2 for the exhaust gas. The turbine rotor 22 is connected to a compressor impeller 25 for conjoint rotation by a turbocharger shaft 26. The compressor impeller 25 is arranged in a compressor housing 24 of a compressor 23 of an exhaust gas turbocharger 3. The compressor impeller 25 is coupled to the internal combustion engine 39 in terms of fluid flow by an intake section 38.

During the operation of the internal combustion engine 39 with the exhaust gas turbocharger 3, the internal combustion engine 39 supplies the turbine rotor 22 with exhaust gas via the exhaust line 41. The turbine rotor 22 lowers the enthalpy of the exhaust gas, and the kinetic and thermal energy of the exhaust gas is converted into rotational energy.

The rotational energy is transmitted to the compressor impeller 25 by the turbocharger shaft 26. The compressor impeller 25 draws in fresh air, compresses it and feeds the compressed fresh air to the internal combustion engine 39 via the intake section 38.

By virtue of the fact that there is more oxygen in the compressed air volume per unit volume, more fuel can be burnt in the internal combustion engine 39 per unit of air volume, thereby increasing the power output of the internal combustion engine 39. Depending on the operating state of the internal combustion engine 39, exhaust gas can be directed past the turbine 2 by means of the waste gate valve 4, e.g. at a constant high speed of a motor vehicle having an internal combustion engine 39 with an exhaust gas turbocharger 3 at full load and high engine speeds. Directing some of the exhaust gas past the turbine 2 reliably prevents overloading of the internal combustion engine 39. By virtue of the fact that the exhaust gas turbocharger 3 has a waste gate arrangement according to the invention, the dimensions of the actuating means required for the adjustment of the waste gate flap 10 can be reduced, as described above. The weight, installation space, production costs and energy consumption of an internal combustion engine 39 having an exhaust gas turbocharger 3 with a waste gate arrangement according to the invention are thereby reduced.

The materials, numerical data and dimensions presented are to be taken as illustrative and serve merely to explain the embodiments and developments of the present invention.

The indicated waste gate arrangement for a turbine, the turbine for an exhaust gas turbocharger and the exhaust gas turbocharger having a turbine can be used to particular advantage in the motor vehicle sector and, in this sector, can preferably be used for passenger vehicles, e.g. with diesel or spark ignition engines, but can also be used in any other turbocharger applications, if required.

1-15. (canceled)

16: A waste gate arrangement for a turbine, the arrangement comprising:
a waste gate valve configured for directing exhaust gas past the turbine;
a waste gate shaft having a first bearing location and a second bearing location configured to rotatably support said waste gate shaft;
a lever arm mounted for conjoint rotation on said waste gate shaft and configured for imparting rotation to said waste gate shaft when a lever arm force is applied to said lever arm; and
a waste gate flap mounted for conjoint rotation on said waste gate shaft and controlling an amount of exhaust gas flowing through said waste gate valve, said waste gate flap being arranged relative to said first and second bearing locations in such a way that a lever arm normal force resulting from said lever arm force and an exhaust gas normal force resulting from an exhaust gas force acting on said waste gate flap have opposite directions of action of force in at least one of said first and second bearing locations during an opening and/or a closing of said waste gate valve.

17: The waste gate arrangement according to claim 16, wherein said lever arm is arranged at a first end of said waste gate shaft, said second bearing location is arranged at a second end of said waste gate shaft, said first bearing location is arranged between said lever arm and said second bearing location, and said waste gate flap is arranged on said waste gate shaft between said first bearing location and said second bearing location.

18: The waste gate arrangement according to claim 16, wherein said waste gate shaft has a larger outside diameter at said first bearing location than at said second bearing location.

19: The waste gate arrangement according to claim 16, wherein said waste gate shaft is formed with two individual shafts, which can be inserted axially one inside the other, wherein said first bearing location is arranged on a first said individual shaft designed as a hollow shaft, and said second bearing location is arranged on a second said individual shaft designed as a solid shaft.

20: The waste gate arrangement according to claim 16, wherein said first and second bearing locations and said waste gate flap are arranged spaced apart in a longitudinal direction of said waste gate shaft.

21: The waste gate arrangement according to claim 20, wherein said first bearing location, said second bearing location and said waste gate flap are spaced apart in such a way in the longitudinal direction of said waste gate shaft that the lever arm normal force and the exhaust gas normal force cancel each other out at a closing point of the waste gate valve in which the waste gate valve is completely closed.

22: The waste gate arrangement according to claim 16, which comprises an arc-shaped intermediate piece coupling said waste gate flap to said waste gate shaft.

23: The waste gate arrangement according to claim 16, wherein said waste gate flap has a rounded valve element.

24: The waste gate arrangement according to claim 16, which comprises an actuating device configured to apply the lever arm force to said lever arm.

25: The waste gate arrangement according to claim 16 configured for an exhaust gas turbocharger.

26: A turbine for an exhaust gas turbocharger, comprising:
a turbine housing; and
a waste gate arrangement according to claim 16;
wherein said waste gate valve, said first bearing location and said second bearing location are arranged in said turbine housing.

27: An exhaust gas turbocharger, comprising:
a turbine with a turbine housing and a waste gate arrangement according to claim 16;
said waste gate valve, said first bearing location and said second bearing location being arranged in said turbine housing;
a turbine rotor arranged in said turbine housing;
a compressor having a compressor housing and a compressor impeller arranged in said compressor housing; and
a turbocharger shaft disposed to connect said compressor impeller to said turbine rotor for conjoint rotation.

28: The exhaust gas turbocharger according to claim 27 configured for a motor vehicle.

29: A motor vehicle, comprising an exhaust gas turbocharger according to claim 28.

30: A method for operating an exhaust gas turbocharger, the method which comprises:
providing the exhaust gas turbocharger with a waste gate arrangement according to claim 16;
selectively operating the exhaust gas turbocharger in a first operating mode for closing the waste gate flap;
during a closing process of the waste gate flap, setting the lever arm normal force and the exhaust gas normal force at the first bearing location to act in mutually opposite directions of action of force and approximately equal, to thereby produce a low bearing friction torque at the first bearing location.

31: The method according to claim 30, which comprises selectively operating the exhaust gas turbocharger in a second operating mode in which the waste gate flap is completely closed, choosing a closing point of the waste gate flap such that the lever arm normal force and the exhaust gas normal force cancel each other out in the first bearing location.

32: The method according to claim 30, which comprises selectively operating the exhaust gas turbocharger in a third operating mode for opening the waste gate flap, wherein the lever arm normal force and the exhaust gas normal force at the first bearing location during the opening process act in opposite directions of action of force and the exhaust gas normal force is greater than the lever arm normal force, thereby producing a high bearing friction torque at the first bearing location.
